(19) United States
(12) Patent Application Publication
(10) Pub. No.: US 2013/0150236 A1
(43) Pub. Date: Jun. 13, 2013

(54) EXHAUST GAS PURIFICATION CATALYST

(71) Applicant: TOYOTA JIDOSHA KABUSHIKI KAISHA, Toyota-shi (JP)

(72) Inventor: Yuki AOKI, Nisshin-shi (JP)

(73) Assignee: TOYOTA JIDOSHA KABUSHIKI KAISHA, Toyota-shi (JP)

(21) Appl. No.: 13/706,634

(22) Filed: Dec. 6, 2012

(30) Foreign Application Priority Data
Dec. 8, 2011 (JP) 2011-269304

(51) Int. Cl. B01J 23/63

(52) U.S. Cl. CPC B01J 23/63
USPC 502/303; 502/304

(57) ABSTRACT

Disclosed is an exhaust gas purification catalyst that is provided with a base material and a catalyst later, which is formed on the base material and has an upstream side catalyst section and a downstream side catalyst section. Ba is added to the upstream side catalyst section and the downstream side catalyst section, the quantity of Ba added to the upstream side catalyst section is a quantity corresponding to 8 to 22 mass % relative to the total mass of a ceria-zirconia composite oxide contained in the upstream side catalyst section, and the quantity of Ba added to the downstream side catalyst section is a quantity corresponding to 3 to 7 mass % relative to the total mass of a ceria-zirconia composite oxide contained in the downstream side catalyst section 45b.

### BACKGROUND OF THE INVENTION

1. Field of the Invention

The present invention relates to an exhaust gas purification catalyst for purifying exhaust gas emitted from an internal combustion engine. Note that this application claims priority under the Paris Convention based on Japanese Patent Application 2011-269304, filed on Dec. 8, 2011, the entire contents of which are incorporated into this application by reference.

2. Description of the Related Art

Exhaust gases emitted from engines of automobiles and the like contain harmful components such as hydrocarbons (HC) carbon monoxide (CO) and nitrogen oxides (NOₓ). Exhaust gas purification catalysts are generally disposed in the exhaust pathway of internal combustion engines in order to eliminate these harmful components from exhaust gases. Such exhaust gas purification catalysts are constituted in such a way that a catalyst layer is formed on the surface of a base material, and the catalyst layer is constituted from a noble metal catalyst and a porous carrier that supports the noble metal catalyst.

In addition, so-called three-way catalysts are widely used as such exhaust gas purification catalysts in order to eliminate harmful components such as hydrocarbons (HC), carbon monoxide (CO) and nitrogen oxides (NOₓ). Such three-way catalysts use platinum (Pt), rhodium (Rh), palladium (Pd) and the like as the above-mentioned noble metal catalyst, and of these noble metal catalysts, platinum and palladium mainly contribute to hydrocarbon (HC) and carbon monoxide (CO) purification performance (oxidative purification performance) and rhodium mainly contributes to nitrogen oxide (NOₓ) purification performance (reductive purification performance).

In exhaust gas purification catalysts in the past, the catalyst layer was divided into a plurality of regions, with each region being formed from a different material, in order to make use of the catalytic function of each catalyst more effectively. For example, Japanese Patent Application Publication No. 2010-005591 discloses an exhaust gas purification catalyst provided with an upstream side catalyst layer provided on the upstream side of the exhaust pathway and a downstream side catalyst layer provided on the downstream side of the exhaust pathway. The upstream side catalyst layer of this exhaust gas purification catalyst contains palladium and is thinner than the downstream side catalyst layer. Meanwhile, the downstream side catalyst layer is constituted from an inner catalyst layer, which contains platinum, barium (Ba) and a zirconia-ceria composite oxide (ZrO₂—CeO₂ composite oxide), and an outer catalyst layer, which contains rhodium and which is formed on the surface of the inner catalyst layer. An exhaust gas purification catalyst having this constitution mainly eliminates HC by means of the upstream side catalyst layer, which contains palladium. In addition, the upstream side catalyst layer is thinner than the downstream side catalyst layer, and can therefore preferably eliminate HC, which hardly diffuse into the catalyst layer.

In addition, Japanese Patent Application Publication No. 2011-183317 and Japanese Patent Application Publication No. 2009-273988 disclose other examples in which catalyst layers of exhaust gas purification catalysts are separated into a plurality of regions.

Japanese Patent Application Publication No. 2011-183317 discloses an exhaust gas purification catalyst which is provided with at least rhodium and palladium as noble metal catalysts and which is further provided with a Zr-based composite oxide and a CeZr-based composite oxide that contains Ce and Zr. In this exhaust gas purification catalyst, a first catalyst layer, which contains rhodium but which does not contain palladium, is disposed on a carrier and a second catalyst layer, which contains palladium but which does not contain rhodium, is disposed closer to the carrier than the first catalyst layer.

Meanwhile, Japanese Patent Application Publication No. 2009-23988 discloses an exhaust gas purification catalyst comprising a carrier base material, an upstream side catalyst layer formed on the carrier base material on the upstream side of the exhaust pathway, and a downstream side catalyst layer formed on the carrier base material on the downstream side of the exhaust pathway. The upstream side catalyst layer contains palladium and barium, and the downstream side catalyst layer contains rhodium.

### SUMMARY OF THE INVENTION

Exhaust gases are in a low temperature state immediately after the engine of an automobile and the like is started. As a result, exhaust gas purification by means of palladium suffers from reduced hydrocarbon (HC) purification performance. That is, some hydrocarbons are not eliminated and remain in low temperature regions immediately after starting an engine, and the remaining hydrocarbons (HC) are adsorbed on the surface of the palladium and form a coating film on the surface of the palladium particles, thereby reducing the number of active sites. As a result, the purification performance of the catalyst deteriorates (HC poisoning of palladium). Therefore, it is preferable for HC poisoning not to occur during exhaust gas purification by means of palladium.

Furthermore, in order to reduce production costs and ensure a stable supply of materials, development of exhaust gas purification catalysts having a low noble metal content has progressed in recent years. In the case of conventional exhaust gas purification catalysts, even if a part of the palladium suffers from HC poisoning, a large quantity of unpoisoned palladium remains and catalyst performance is hardly affected. However, in the case of exhaust gas purification catalysts having a low noble metal content, the quantity of noble metal catalysts used is low, and HC poisoning of palladium has a major effect.

The present invention was devised in order to solve the problems mentioned above, has the objective of preventing HC poisoning of palladium in an exhaust gas purification catalyst (and especially in an exhaust gas purification catalyst having a low noble metal content), and provides an exhaust gas purification catalyst able to achieve this objective.

In order to achieve the objective mentioned above, the present invention provides an exhaust gas purification catalyst having the following constitution. That is, the exhaust gas purification catalyst of the present invention is an exhaust gas purification catalyst that purifies exhaust gases emitted from internal combustion engines, and is provided with a porous base material and a catalyst layer formed on the porous base material. The catalyst layer has at least a ceria-zirconia composite oxide as a carrier and has palladium as a noble metal catalyst supported on the carrier. In addition, the catalyst layer is provided with at least an upstream side catalyst section disposed on the upstream side in the exhaust gas flow direction and a downstream side catalyst section disposed on the downstream side in the exhaust gas flow direction. In addition, Ba (barium) is added to the upstream side catalyst section and the downstream side catalyst section. A quantity of Ba added to the upstream side catalyst section is a quantity corresponding to 8 mass % to 22 mass % (and preferably 9 mass % to 20 mass %, and more preferably 1 mass % to 16 mass %) when a total mass of the ceria-zirconia composite oxide contained in the upstream side catalyst section is 100 mass %. In addition, a quantity of Ba added to the downstream side catalyst section is a quantity corresponding to 3 mass % to 7 mass % (and preferably 4 mass % to 6 mass %) when the total mass of the ceria-zirconia composite oxide contained in the downstream side catalyst section is 100 mass %.

The exhaust gas purification catalyst has at least the ceria-zirconia composite oxide as the carrier. The ceria (CeO₂) contained in the ceria-zirconia composite oxide has oxygen storage capacity, and therefore contributes to stably maintaining the exhaust gas air-fuel ratio. In addition, the zirconia (ZrO₂) inhibits the growth of ceria grains (sintering) in high-temperature regions. As a result, the ceria-zirconia composite oxide can effectively achieve HC purification performance by stably maintaining the exhaust gas air-fuel ratio, and also exhibits excellent heat resistance.

In addition, HC poisoning (and especially olefin poisoning) of palladium occurs little in this exhaust gas purification catalyst compared to a conventional exhaust gas purification catalyst which does not contain Ba or in which the added quantity of Ba does not fall within the range mentioned above. As a result, HC poisoning of palladium is effectively suppressed even immediately after an engine is started, and it is possible to achieve high catalyst activity (and especially low temperature activity). This is thought to be because the Ba added to the carrier and the palladium that is the noble metal catalyst interact with each other, thereby maintaining a low palladium valency and facilitating desorption of HC adsorbed on the palladium. In addition, in cases where the quantity of Ba added to the upstream side catalyst section and the downstream side catalyst section exceeds the range mentioned above, there are concerns that excess Ba will cause the crystal structure of the ceria-zirconia composite oxide to be destroyed. In such cases, there are concerns that the oxygen storage capacity of the ceria-zirconia composite oxide will deteriorate, meaning that the exhaust gas fuel-air ratio cannot be stably maintained.

In addition, in an exhaust gas purification catalyst having this constitution, because an appropriate quantity of Ba is added to the carrier, the dispersibility of the palladium supported on the carrier improves. As a result, sintering of palladium can be more effectively suppressed in high-temperature regions, and it is possible to improve the durability of the catalyst. Therefore, according to the present invention, it is possible to provide the exhaust gas purification catalyst in which HC poisoning of palladium is suppressed compared to conventional exhaust gas purification catalysts, in which sintering of palladium is further suppressed, and which has good purification performance.

In addition, in the exhaust gas purification catalyst having this constitution, the upstream side catalyst section eliminates HC from the exhaust gas, residual exhaust gas HC that could not be eliminated by the upstream side catalyst section is eliminated by the downstream side catalyst section, and the upstream side catalyst section is more susceptible to HC poisoning of palladium than the downstream side catalyst section. As a result, the exhaust gas purification catalyst of the present invention is characterized in that the mass ratio of the Ba added to the upstream side catalyst section relative to the ceria-zirconia composite oxide contained in the upstream side catalyst section is higher than the mass ratio of the Ba added to the downstream side catalyst section relative to the ceria-zirconia composite oxide contained in the downstream side catalyst section. Therefore, HC poisoning of the palladium in the upstream side catalyst section occurs less readily, and it is possible to achieve higher catalyst activity (and especially low temperature activity).

In addition, in a preferred aspect of the exhaust gas purification catalyst disclosed here, the length of the upstream side catalyst section in the exhaust gas flow direction accounts for at least 10% to 20% of the overall length of the catalyst layer along this direction from the exhaust gas inlet side end. Meanwhile, the length of the downstream side catalyst section in the exhaust gas flow direction accounts for at least 80% to 90% of the overall length of the catalyst layer along this direction from the exhaust gas outlet side end.

In an exhaust gas purification catalyst having this constitution, by setting the length of the upstream side catalyst section in the exhaust gas flow direction and the length of the downstream side catalyst section in the exhaust gas flow direction to have the ratios mentioned above, it is possible to more preferably suppress HC poisoning and sintering of palladium through the addition of Ba. Therefore, it is possible to ensure superior catalyst activity.

In addition, in another preferred aspect of the exhaust gas purification catalyst disclosed here, the content of the ceria-zirconia composite oxide contained in the downstream side catalyst section is higher than the content of the ceria-zirconia composite oxide contained in the upstream side catalyst section.

The ceria contained in the ceria-zirconia composite oxide has oxygen storage capacity (OSC), and the zirconia contained in the ceria-zirconia composite oxide suppresses sintering of the ceria in high-temperature regions.

An exhaust gas purification catalyst having this constitution eliminates HC from an exhaust gas mainly by means of the palladium supported in the upstream side catalyst section, especially in low-temperature regions when an engine is started. Meanwhile, HC are eliminated from exhaust gas in high-temperature regions mainly by palladium supported on the downstream side catalyst section. Therefore, by incorporating a ceria-zirconia composite oxide, which can achieve catalyst performance in high-temperature regions, at a greater quantity in the downstream side catalyst section than in the upstream side catalyst section, it is possible to achieve superior catalyst performance especially in the downstream side catalyst section.

In addition, in another preferred aspect of the exhaust gas purification catalyst disclosed here, the upstream side catalyst section and the downstream side catalyst section further contain alumina as the carrier. According to this constitution, it is possible to achieve superior catalyst activity by making use of the large specific surface area and high durability (and especially heat resistance) of the alumina.

In addition, in another preferred aspect of the exhaust gas purification catalyst disclosed here, a quantity of palladium supported on the carrier in the upstream side catalyst section is a quantity corresponding to 0.5 mass % to 3 mass % (and especially 0.5 mass % to 1.5 mass %) if the total mass of the carrier is 100 mass %, and a quantity of palladium supported on the carrier in the downstream side catalyst section is a quantity corresponding to 0.1 mass % to 1 mass % (and especially 0.1 mass % to 0.8 mass %) if the total mass of the carrier is 100 mass %. In addition, the quantity of palladium supported in the upstream side catalyst section is higher than the quantity of palladium supported in the downstream side catalyst section.

If the supported quantities of palladium fail within the ranges mentioned above, a satisfactory catalyst effect is achieved by the palladium and costs are not excessive. In addition, HC are eliminated from exhaust gases mainly by the palladium supported in the upstream side catalyst section, especially in low temperature regions when an engine is started, and because residual exhaust gas HC that could not be eliminated by the upstream side catalyst section are eliminated by the downstream side catalyst section, it is possible to achieve superior catalyst performance by making the quantity of palladium supported in the upstream side catalyst section higher than the quantity of palladium supported in the downstream side catalyst section.

In addition, in another preferred aspect of the exhaust gas purification catalyst disclosed here, a rhodium catalyst layer, which is provided with at least one type of carrier and has rhodium supported on the carrier, is further formed on the surface of the catalyst layer in the downstream side catalyst section.

In an exhaust gas purification catalyst having this constitution, it is possible to make use of the NOₓ purification performance (reductive purification performance) of rhodium by forming the rhodium catalyst layer. In addition, because it is possible to achieve CO and HC purification performance (oxidative purification performance) by means of palladium in the upstream side catalyst section and the downstream side catalyst section, the catalyst layer functions as a so-called three-way catalyst. Therefore, it is possible to effectively eliminate harmful components contained in exhaust gases emitted from internal combustion engines.

### BRIEF DESCRIPTION OF THE DRAWINGS

FIG. 1 is a schematic diagram of an exhaust gas purification apparatus according to one embodiment of the present invention;

FIG. 2 is a schematic diagram of an exhaust gas purification catalyst according to one embodiment of the present invention;

FIG. 3 is a schematic diagram of an exhaust gas purification catalyst according to one embodiment of the present invention, in which a cross section of the catalyst is expanded;

FIG. 4 is a graph showing the relationship between the added quantity of Ba in the upstream side catalyst section and the time required for elimination of 50% of HC; and

FIG. 5 is a graph showing the relationship between the added quantity of Ba in the downstream side catalyst section and the temperature required for elimination of 50% of HC.

### DESCRIPTION OF THE EMBODIMENTS

A preferred embodiment of the present invention will now be explained. Moreover, matters which are essential for carrying out the invention and which are matters other than those explicitly mentioned in the present description are matters that a person skilled in the art could understand to be matters of design on the basis of the prior art in this technical field. The present invention can be carried out on the basis of the matters disclosed in the present description and common technical knowledge in this technical field.

In the present description, “rich exhaust gas” means an exhaust gas produced by burning a mixed gas in which the air-fuel ratio is rich (A/F<14.7). Meanwhile, in the present description, “lean exhaust gas” means an exhaust gas produced by burning a mixed gas in which the air-fuel ratio is lean (A/F>14.7). In addition, in the present description, “slightly lean exhaust gas” means an exhaust gas produced by burning a mixed gas in which the air-fuel ratio is close to the stoichiometric ratio of 14.7±0.05.

<Exhaust Gas Purification Apparatus>

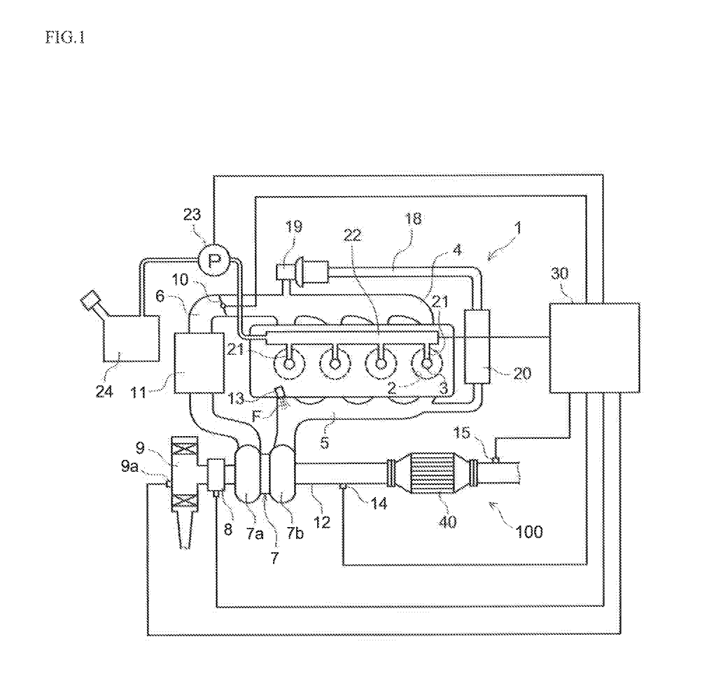

First, an explanation will be given of an exhaust gas purification apparatus provided with an exhaust gas purification catalyst according to one embodiment of the present invention. This exhaust gas purification apparatus is provided in the exhaust system of an internal combustion engine. Explanations will now be given of an internal combustion engine and an exhaust gas purification apparatus with reference to FIG. 1.

A. Internal Combustion Engine

An internal combustion engine 1 having the constitution shown in FIG. 1 is provided with a plurality of combustion chambers 2 and fuel injection valves 3 that inject fuel into the combustion chambers 2. Each of the fuel injection valves 3 is connected to a common rail 22 via a fuel supply tube 21. The common rail 22 is connected to a fuel tank 24 via a fuel pump 23. The fuel pump 23 supplies fuel housed in the fuel tank 24 to the combustion chambers 2 via the common rail 22, the fuel supply tubes 21 and the fuel injection valves 3.

In addition, each of the combustion chambers 2 is connected to an intake manifold 4 and an exhaust manifold 5. Hereinafter, a system which supplies air (oxygen) to the internal combustion engine 1 and which is provided on the upstream side of the intake manifold 4 is referred to as an “induction system”. In addition, a system which emits exhaust gas generated by the internal combustion engine 1 to the outside and which is provided on the downstream side of the exhaust manifold 5 is referred to as an “exhaust system”. Moreover, the induction system and the exhaust system are connected to each other via an exhaust gas recirculation pathway 18. In addition, an electronically controlled control valve 19 is disposed in the exhaust gas recirculation pathway 18, and it is possible to adjust the exhaust gas being recirculated by opening and closing the control valve 19. In addition, a cooling device 20 is disposed in the exhaust gas recirculation pathway 18 in order to cool gas flowing inside the exhaust gas recirculation pathway 18.

A-1. Induction System

Next, an explanation will be given of the induction system of the internal combustion engine 1. An air intake duct 6 is connected to the intake manifold 4, which connects the internal combustion engine 1 to the induction system, This air intake duct 6 is connected to a compressor 7a of an exhaust turbocharger 7, and an air cleaner 9 is connected to the compressor 7a. An intake air temperature sensor 9a, which detects the temperature of air being drawn in from outside the internal combustion engine (the intake air temperature), is attached to the air cleaner 9. In addition, an air flow meter 8 is disposed on the downstream side (the internal combustion engine 1 side) of the air cleaner 9. The air flow meter 8 is a sensor that detects the quantity of intaken air supplied to the air intake duct 6. A throttle valve 10 is provided in the air intake duct 6 at a position further downstream than the air flow meter 8. By opening and closing this throttle valve 10, it is possible to adjust the quantity of air supplied to the internal combustion engine 1. In addition, a throttle sensor (not shown), which detects the degree of opening of the throttle valve 10, may be disposed near the throttle valve 10. In addition, it is preferable for a cooling device 11, which is used to cool air flowing inside the air intake duct 6, to be provided around the air intake duct 6.

A-2. Exhaust System

Next, an explanation will be given of the exhaust system of the internal combustion engine 1. The exhaust manifold 5, which connects the internal combustion engine 1 to the exhaust system, is connected to an exhaust turbine 7b of the exhaust turbocharger 7. An exhaust pathway 12, through which exhaust gas flows, is connected to the exhaust turbine 7b. Moreover, an exhaust system fuel injection valve 13, which injects fuel F into the exhaust gas, may be provided in the exhaust system (for example, in the exhaust manifold 5). This exhaust system fuel injection valve 13 injects fuel F into the exhaust gas, thereby enabling adjustment of the air-fuel ratio (A/F) of the exhaust gas supplied to an exhaust gas purification catalyst 40, which is described later.

B. Exhaust Gas Purification Apparatus

The exhaust gas purification apparatus 100 disclosed here is provided in the exhaust system of the internal combustion engine 1. The exhaust gas purification apparatus 100 is provided with the exhaust gas purification catalyst 40 and a control unit 30, and eliminates harmful components contained in the exhaust gas flowing in the exhaust system, such as carbon monoxide (CO), hydrocarbons (HC) and nitrogen oxides (NOₓ). In addition, the exhaust gas purification apparatus 100, which has the constitution shown in FIG. 1, is provided with a catalyst upstream sensor 14 and a catalyst downstream sensor 15.

C. Exhaust Gas Purification Catalyst

The exhaust gas purification catalyst 40 disclosed here is disposed in the exhaust system of the internal combustion engine 1. In the exhaust gas purification apparatus 100 having the constitution shown in FIG. 1, the exhaust gas purification catalyst 40 is disposed in the exhaust pathway 12 of the exhaust system. This exhaust gas purification catalyst 40 will be explained in greater detail later.

D. Catalyst Upstream Sensor

The exhaust gas purification apparatus 100 disclosed here may be provided with the catalyst upstream sensor 14 at a position upstream of the exhaust gas purification catalyst 40 in the exhaust system. In the exhaust gas purification apparatus 100 having the constitution shown in FIG. 1, the catalyst upstream sensor 14 is disposed upstream of the exhaust gas purification catalyst 40 in the exhaust pathway 12. The catalyst upstream sensor 14 can detect the air-fuel ratio in the exhaust gas upstream of the exhaust gas purification catalyst 40. By inputting the air-fuel ratio in the exhaust gas upstream of the exhaust gas purification catalyst 40, as detected by the catalyst upstream sensor 14, into a prescribed calculation formula, it is possible to estimate the air-fuel ratio in the mixed gas supplied to the internal combustion engine 1. For example, the control unit 30, which will be described later, receives the air-fuel ratio in the exhaust gas upstream of the exhaust gas purification catalyst 40, as detected by the catalyst upstream sensor 14, and the control unit 30 calculates the air-fuel ratio in the mixed gas supplied to the internal combustion engine 1 on the basis of the air-fuel ratio in the exhaust gas.

E. Catalyst Downstream Sensor

The exhaust gas purification apparatus 100 disclosed here is provided with the catalyst downstream sensor 15 at a position downstream of the exhaust gas purification catalyst 40 in the exhaust system. In the exhaust gas purification apparatus 100 having the constitution shown in FIG. 1, the catalyst downstream sensor is disposed at a position downstream of the exhaust gas purification catalyst 40 in the exhaust pathway 12.

The catalyst downstream sensor 15 should be able to detect the air-fuel ratio in the exhaust gas downstream of the exhaust gas purification catalyst 40, and the specific constitution of the catalyst downstream sensor 15 does not particularly limit the present invention. For example, the catalyst downstream sensor 15 can be an oxygen sensor that detects the oxygen concentration in the exhaust gas. One example of this oxygen sensor is a 0V-1V oxygen sensor that generates a potential of 1 V when in contact with rich exhaust gas and generates a potential of 0 V when in contact with lean exhaust gas. By using this 0V-1V oxygen sensor, it is possible to detect fluctuations in the air-fuel ratio of the exhaust gas downstream of the exhaust gas purification catalyst 40 by fluctuations in the detected potential. In addition, another example of the catalyst downstream sensor 15 is an A/F sensor (air-fuel ratio sensor). The A/F sensor detects the oxygen concentration in the exhaust gas and detects the air-fuel ratio in the exhaust gas on the basis of this oxygen concentration.

F. Control Unit (ECU)

Next, an explanation will be given of the control unit (ECU) 30 of the exhaust gas purification apparatus 100 disclosed here. The control unit 30 is constituted mainly from a digital computer, and functions as a device for controlling operation of the internal combustion engine 1 and the exhaust gas purification apparatus 100. The control unit 30 has a ROM, which is a read-only storage device, a RAM, which is a readable and writable storage device, and a CPU, which carries out arbitrary calculations and discriminations.

Input ports are provided in the control unit 30 having the constitution shown in FIG. 1, and sensors disposed at various points in the internal combustion engine 1 and the exhaust gas purification catalyst 40 are electrically connected to the control unit 30. In this way, data detected by the sensors is transmitted as electrical signals via the input ports to the ROM, RAM and CPU. In addition, output ports are provided in the control unit 30. The control unit 30 is connected via the output ports to various points in the internal combustion engine 1, and controls the operation of various members by transmitting control signals.

On the basis of the oxygen concentration in the exhaust gas upstream of the exhaust gas purification catalyst 40, as detected by the catalyst upstream sensor 14, the control unit 30 can estimate the air-fuel ratio (A/F) in the mixed gas burned in the internal combustion engine 1. In addition, on the basis of the oxygen concentration in the exhaust gas downstream of the exhaust gas purification catalyst 40, as detected by the catalyst downstream sensor 15, the control unit 30 can detect whether the exhaust gas passing through the exhaust gas purification catalyst 40 is a rich exhaust gas or a lean exhaust gas.

In addition, as mentioned above, the control unit 30 can adjust the air-fuel ratio of the mixed gas supplied to the internal combustion engine 1 on the basis of the detection results from the catalyst downstream sensor 15 and the catalyst upstream sensor 14.

In the exhaust gas purification apparatus 100 having the constitution shown in FIG. 1, the control unit 30 calculates the air-fuel ratio in the mixed gas supplied to the internal combustion engine 1 on the basis of the exhaust gas air-fuel ratio detected by the catalyst downstream sensor 15 and the catalyst upstream sensor 14. In addition, the control unit 30 produces control signals on the basis of the calculated air-fuel ratio and the target air-fuel ratio, and transmits these control signals to various components in the internal combustion engine 1. For example, the control unit 30 is electrically connected to the fuel pump 23 and the fuel injection valves 3, and can adjust the fuel supplied to the internal combustion engine 1 by controlling the operation of the fuel pump 23 and the timing of the opening and closing of the fuel injection valves 3. Meanwhile, the control unit 30 is also connected to the throttle valve 10 provided in the air intake duct 6 in the induction system, and can adjust the quantity of air supplied to the internal combustion engine 1 by controlling the timing of the opening and closing of the throttle valve 10. The control unit 30 can control the air-fuel ratio of the mixed gas supplied to the internal combustion engine 1 by controlling the fuel pump 23 or the fuel injection valves 3 so as to adjust the quantity of fuel supplied and controlling the throttle valve 10 so as to adjust the quantity of air supplied.

Moreover, if the internal combustion engine 1 is operating normally, the control unit 30 adjusts the air-fuel ratio of the mixed gas supplied to the internal combustion engine 1 so as to be close to the stoichiometric ratio (A/F=14.7). If the air-fuel ratio of the mixed gas is adjusted to be close to the stoichiometric ratio, the fuel combustion efficiency in the internal combustion engine 1 is at a maximum, and the exhaust gas purification performance of the exhaust gas purification catalyst 40 is also maximized.

<Exhaust Gas Purification Catalyst>

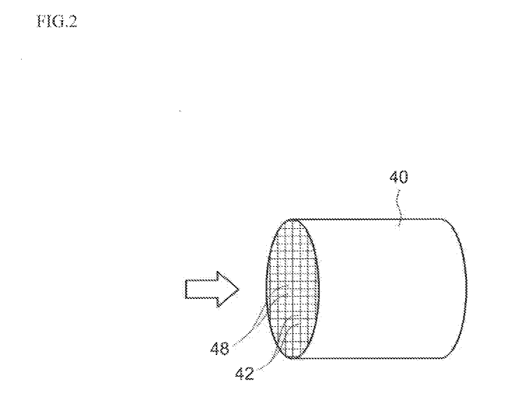

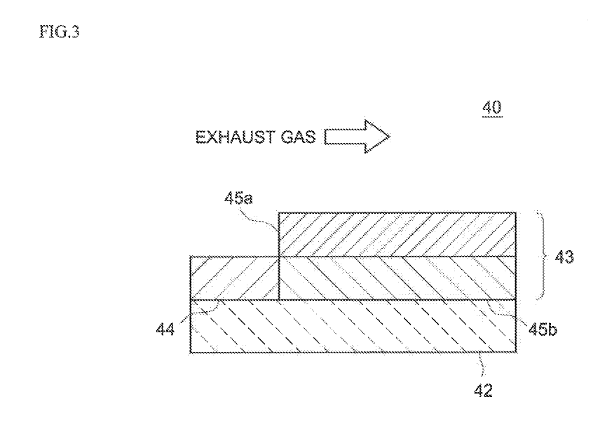

Next, an explanation will be given of the detailed constitution of the exhaust gas purification catalyst 40 disclosed in the present invention. This exhaust gas purification catalyst 40 is constituted in such a way that a catalyst layer is formed on a base material, and the catalytic function of the catalyst layer eliminates harmful components contained in an exhaust gas. One example of the exhaust gas purification catalyst is shown in FIG. 2 and FIG. 3. FIG. 2 is a perspective view showing a schematic representation of the exhaust gas purification catalyst 40, and FIG. 3 is an expanded view showing a schematic representation of one example of the cross sectional constitution of the exhaust gas purification catalyst 40.

1. Base Material

The base material of the exhaust gas purification catalyst disclosed here can be any of a variety of materials and forms used in conventional applications. For example, the base material is preferably constituted from a heat-resistant material having a porous structure. This heat-resistant material can be cordierite, silicon carbide (SiC), aluminum titanate, silicon nitride, or a heat-resistant metal such as stainless steel or an alloy thereof. In addition, the base material preferably has a honeycomb structure, a foam-like form, a pellet-like shape and the like. Moreover, the outer shape of the overall base material can be cylindrical, elliptic cylindrical, polygonal cylindrical and the like. In the exhaust gas purification catalyst 40 having the constitution shown in FIG. 2, a cylindrical member having a honeycomb structure is used as a base material 42. This base material 42 having a honeycomb structure has a plurality of flow pathways 48 along the cylindrical axis direction, which is the direction in which the exhaust gas flows. In addition, the capacity of the base material 42 (the volume of the flow pathways 48 in the base material 42) should be 0.1 L or higher (and preferably 0.5 L or higher) and 5 L or lower (and preferably 3 L or lower, and more preferably 2 L or lower).

2. Catalyst Layer

A catalyst layer 43 is formed on the base material 42. This catalyst layer 43 is provided with a noble metal catalyst and a carrier that supports the noble metal catalyst. In the exhaust gas purification catalyst 40 having the constitution shown in FIG. 3, the catalyst layer 43 is formed on the surface of the base material 42. The exhaust gas supplied to the exhaust gas purification catalyst 40 flows through the flow pathways 48 in the base material 42, and harmful components are eliminated through contact with the catalyst layer 43. For example, CO and HC contained in the exhaust gas are oxidized by the catalyst layer 43 and converted (purified) into water (H₂O), carbon dioxide (CO₂) and the like, and NOₓ are reduced by the catalyst layer 43 and converted (purified) into nitrogen (N₂).

In the exhaust gas purification catalyst 40 disclosed here, the catalyst layer 43 is divided into a plurality of layers (regions) and comprises at least an upstream side region (an upstream side catalyst section) 44 and a downstream side region (a downstream side catalyst section) 45b. As shown in FIG. 3, the upstream side catalyst section 44 is provided on the upstream side in the direction in which the exhaust gas flows, and the downstream side catalyst section 45b is provided on the downstream side in the direction in which the exhaust gas flows (further downstream than the upstream side catalyst section 44). In addition, the catalyst in the exhaust gas purification catalyst 40 disclosed here may be divided into three or more regions. For example, it is possible to provide a region having a different constitution from both the upstream side catalyst section 44 and the downstream side catalyst section 45b between the upstream side catalyst section 44 and the downstream side catalyst section 45b.

2-1. Upstream Side Catalyst Section

The upstream side catalyst section 44 disclosed here is formed on the base material on the upstream side in the direction in which the exhaust gas flows. This upstream side catalyst section 44 comprises a ceria-zirconia composite oxide (CeO₂—ZrO₂ composite oxide) as a carrier and has palladium supported as a noble metal catalyst on the carrier. In addition, Ba is added to the carrier. In addition, the quantity of Ba added to the upstream side catalyst section 44 is a quantity corresponding to 8 mass % to 22 mass %, preferably 9 mass % to 20 mass %, and more preferably 1 mass % to 16 mass %, if the total mass of the ceria-zirconia composite oxide contained in the upstream side catalyst section 44 is 100 mass %. If the range of the quantity of Ba added to the upstream side catalyst section 44 is calculated as a ratio relative to the carrier contained in the upstream side catalyst section 44, this added quantity range is a quantity corresponding to 4 mass % to 12 mass %, preferably 4.5 mass % to 10 mass %, and more preferably 5 mass % to 8.5 mass %, if the total mass of the carrier is 100 mass %. In addition, the length of the upstream side catalyst section 44 in the exhaust gas flow direction accounts for at least 10% to 20% of the overall length of the catalyst layer along this direction from the exhaust gas inlet side end.

2-2. Downstream Side Catalyst Section

The downstream side catalyst section 45b disclosed here is formed on the base material on the downstream side in the direction in which the exhaust gas flows. Like the upstream side catalyst section 44, this downstream side catalyst section 45b comprises a ceria-zirconia composite oxide (CeO₂—ZrO₂ composite oxide) as a carrier and has palladium supported as a noble metal catalyst on the carrier. In addition, Ba is added to the carrier. In addition, the quantity of Ba added to the downstream side catalyst section 45b is a quantity corresponding to 3 mass % to 7 mass %, and preferably 4 mass % to 6 mass %, if the total mass of the ceria-zirconia composite oxide contained in the downstream side catalyst section 45b is 100 mass %. If the range of the quantity of Ba added to the downstream side catalyst section 45b is calculated as a ratio relative to the carrier contained in the downstream side catalyst section 45b, this added quantity range is a quantity corresponding to 1.5 mass % to 4 mass %, and preferably 2 mass % to 3.5 mass %, if the total mass of the carrier is 100 mass %. A rhodium catalyst layer 45a, which is provided with at least one type of carrier and has rhodium supported on the carrier, may be further formed on the surface of the downstream side catalyst section 45b. By forming this rhodium catalyst layer 45a, it is possible to eliminate NO_{X} in the exhaust gas by means of the reductive purification performance of rhodium.

In addition, the length of the downstream side catalyst section 45b in the exhaust gas flow direction accounts for at least 80% to 90% of the overall length of the catalyst layer 43 along this direction from the exhaust gas outlet side end. By setting the length of the upstream side catalyst section 44 in the exhaust gas flow direction and the length of the downstream side catalyst section 45b in the exhaust gas flow direction to have the ratios mentioned above, it is possible to more preferably suppress HC poisoning and sintering of palladium through the addition of Ba. Therefore, it is possible to ensure superior catalyst activity.

3. Noble Metal Catalyst

In the upstream side catalyst section 44 and the downstream side catalyst section 45b in the present invention, palladium (Pd), which exhibits oxidation performance for eliminating HC and CO, which are harmful components contained in exhaust gas, is supported as a noble metal catalyst on the carrier in the upstream side catalyst section 44 and the downstream side catalyst section 45b, but it is possible to further incorporate other noble metal catalysts having catalytic activity in order to eliminate harmful components contained in exhaust gas. Metals other than palladium able to be used in the noble metal catalyst include, for example, any metal belonging to the platinum group or an alloy mainly comprising any metal belonging to the platinum group. Metals belonging to the platinum group include palladium, but also include platinum (Pt), rhodium (Rh), ruthenium (Ru), iridium (Ir) and osmium (Os). For example, it is possible to further incorporate platinum (Pt), which exhibits oxidation performance for eliminating HC and CO, in the upstream side catalyst section 44 and the downstream side catalyst section 45b.

In addition, it is possible to further incorporate rhodium (Rh), which exhibits reduction performance for eliminating NOₓ, in the upstream side catalyst section 44 and the downstream side catalyst section 45b, but if palladium and rhodium are contained in the same catalyst layer, the palladium and rhodium react with each other at high temperatures to form an alloy, which leads to concerns regarding the NOₓ purification performance of the rhodium deteriorating. Therefore, it is preferable to incorporate palladium and rhodium in different catalyst layers, as mentioned above.

In addition, in the present invention, the rhodium catalyst layer 45a is further provided on the downstream side catalyst section 45b, but by providing the rhodium catalyst layer 45a on the downstream side catalyst section 45b only, and not on the surface of the upstream side catalyst section 44, it is possible to increase the dispersibility of CO and HC into the downstream side catalyst section 45b, thereby facilitating elimination of CO and HC in the downstream side catalyst section 45b.

In addition, the exhaust gas purification catalyst 40 of the exhaust gas purification apparatus 100 disclosed here is an exhaust gas purification catalyst having a lower content of noble metals than a conventional exhaust gas purification catalyst. Specifically, the quantity of palladium supported on the carrier of the upstream side catalyst section 44 of the exhaust gas purification catalyst 40 disclosed here is a quantity corresponding to 0.5 mass % to 3 mass %, and preferably 0.5 mass % to 1.5 mass %, if the total mass of the carrier is 100 mass %. Meanwhile, the quantity of palladium supported on the carrier of the downstream side catalyst section 45b is a quantity corresponding to 0.1 mass % to 1 mass %, and preferably 0.1 mass % to 0.8 mass %, if the total mass of the carrier is 100 mass %. Therefore, the exhaust gas purification catalyst 40 disclosed here has a lower content of noble metals than a conventional exhaust gas purification catalyst. Therefore, in the exhaust gas purification apparatus 100 disclosed here, reducing the content of noble metals contributes to a reduction in production costs and a stable supply of materials.

In addition, in the exhaust gas purification catalyst 40 disclosed here, the quantity of palladium supported in the upstream side catalyst section 44 is greater than the quantity of palladium supported in the downstream side catalyst section 45b. HC are eliminated from exhaust gases mainly by the palladium supported in the upstream side catalyst section 44, especially in low temperature regions when an engine is started, and because residual exhaust gas HC that could not be eliminated by the upstream side catalyst section 44 are eliminated by the downstream side catalyst section 45b, and it is therefore possible to achieve superior catalyst performance by making the quantity of palladium supported in the upstream side catalyst section 44 higher than the quantity of palladium supported in the downstream side catalyst section 45b.

4. Carrier

The upstream side catalyst section 44 and the downstream side catalyst section 45b provided in the catalyst layer 43 are provided with at least a ceria-zirconia composite oxide as a carrier. The composite oxide is an OSC material, and exhibits oxygen storage capacity, that is, absorbs oxygen when a lean exhaust gas is supplied and discharges absorbed oxygen when a rich exhaust gas is supplied. Therefore, it is possible to more preferably eliminate harmful components contained in an exhaust gas.

The blending ratio of ceria and zirconia in the ceria-zirconia composite oxide is such that the ceria/zirconia ratio is 0.25 to 0.75, preferably 0.3 to 0.6, and more preferably approximately 0.5.

In addition, in the exhaust gas purification catalyst 40 disclosed here, the content of the ceria-zirconia composite oxide contained in the downstream side catalyst section 45b is higher than the content of the ceria-zirconia composite oxide contained in the upstream side catalyst section 44. HC are eliminated from exhaust gas in low temperature regions when an engine is started mainly by palladium supported on the upstream side catalyst section 44. Meanwhile, HC are eliminated from exhaust gas in high temperature regions mainly by palladium supported on the downstream side catalyst section 45b. Therefore, by incorporating a ceria-zirconia composite oxide, which can achieve catalyst performance in high-temperature regions, at a greater quantity in the downstream side catalyst section 45b than in the upstream side catalyst section 44, it is possible to achieve superior oxygen storage capacity in the downstream side catalyst section 45b in particular.

The form (shape) of the carrier having a ceria-zirconia composite oxide is not particularly limited, but is preferably a form whereby it is possible to constitute the carrier with a large specific surface area. For example, the specific surface area of the carrier (as measured by the BET method, hereinafter also measured using this method) is preferably 20 m²/g to 80 m²/g, and more preferably 40 m²/g to 60 m²/g. In order to realize a carrier having such a specific surface area, a powdered (particulate) form is preferred. In order to realize a carrier having a more preferred specific surface area, the average particle diameter of a powdered ceria-zirconia composite oxide is preferably 5 nm to 20 nm, and more preferably 7 nm to 12 nm. If the average particle diameter of the particles is too high (or if the specific surface area is too small), the dispersibility of the noble metal tends to deteriorate when supporting the noble metal catalyst on the carrier, thereby causing the purification performance of the catalyst to deteriorate. Meanwhile, if the particle diameter of the particles is too low (or if the specific surface area is too high), the heat resistance of the carrier per se deteriorates and the heat resistance of the catalyst deteriorates.

In addition, in the exhaust gas purification catalyst 40 disclosed here, the carrier may contain a carrier material other than an OSC material such as a ceria-zirconia composite oxide (a non-OSC material). A porous metal oxide having excellent heat resistance may be preferably used as this non-OSC material. It is preferable for this non-OSC material to be, for example, aluminum oxide (alumina: Al₂O₃), zirconium oxide (zirconia: ZrO₂), silicon oxide (silica: SiO₂) or a composite oxide mainly comprising these metal oxides. Of these, alumina and zirconia satisfy the preferred conditions for a carrier material mentioned above and are inexpensive, and are therefore particularly preferred, Carriers that contain these non-OSC materials have large specific surface areas and can be produced inexpensively, and are therefore preferred.

For example, if the carrier further contains alumina, the blending ratio of the ceria-zirconia composite oxide and the alumina in the carrier (ceria-zirconia composite oxide:alumina) is preferably between 20:80 and 80:20. By blending within the range mentioned above, the effect achieved by using both the ceria-zirconia composite oxide and the alumina (for example, the high specific surface area and high durability (especially heat resistance) exhibited by the alumina and the oxygen storage capacity exhibited by the ceria-zirconia composite oxide) can be suitably achieved. If the blending proportion of the ceria-zirconia composite oxide is too low, the oxygen storage capacity of the overall carrier tends to deteriorate, but if the blending proportion of the alumina is too low, the thermal stability of the overall carrier deteriorates, the specific surface area decreases, and it becomes difficult to support the required quantity of palladium.

5. Barium Compound

As mentioned above, one feature of the exhaust gas purification catalyst 40 disclosed here is that a barium (Ba) compound is added to the upstream side catalyst section 44 and the downstream side catalyst section 45b. The barium compound can be one that exhibits high oxygen storage capacity when exposed to slightly lean exhaust gas having an A/F ratio of close to 147 (for example, A/F=14.7±0.05) and can improve the oxygen absorption quantity of the overall exhaust gas purification catalyst. This barium compound can be, for example, barium acetate ((CH₃COO)₂Ba), barium sulfate (BaSO₄), barium nitrate ((BaNO₃)₂) or barium oxalate (BaC₂O₄.2H₂O). Of these, barium acetate exhibits particularly high oxygen storage capacity when exposed to slightly lean exhaust gas, and is therefore preferred.

In addition, the quantity of Ba added to the upstream side catalyst section 44 is a quantity corresponding to 8 mass % to 22 mass %, preferably 9 mass % to 20 mass %, and more preferably 11 mass % to 16 mass %, if the total mass of the ceria-zirconia composite oxide contained in the upstream side catalyst section 44 is 100 mass %. In addition, the quantity of Ba added to the downstream side catalyst section 45b is a quantity corresponding to 3 mass % to 7 mass %, and preferably 4 mass % to 6 mass %, if the total mass of the ceria-zirconia composite oxide contained in the downstream side catalyst section 45b is 100 mass %. If the quantities of Ba added to the upstream side catalyst section 44 and the downstream side catalyst section 45b are lower than the ranges mentioned above, there are concerns that the preferred oxygen absorption quantity cannot be achieved even if slightly lean exhaust gas is supplied. Meanwhile, if the quantities of Ba added to the upstream side catalyst section 44 and the downstream side catalyst section 45b exceed the ranges mentioned above, there are concerns that the catalytic activity of the exhaust gas purification catalyst 40 will deteriorate due to the Ba covering the surface of the carrier or the noble metal catalyst. In addition, there are concerns that an excessive quantity of Ba will cause the crystal structure of the ceria-zirconia composite oxide to be destroyed. In such cases, there are concerns that the oxygen storage capacity of the ceria-zirconia composite oxide will deteriorate, meaning that fuel-air ratio of the exhaust gas cannot be stably maintained. Therefore, by setting the quantity of Ba added to the upstream side catalyst section 44 and the downstream side catalyst section 45b to fall within the numerical ranges mentioned above, it is possible to achieve the preferred oxygen absorption quantity when slightly lean exhaust gas is supplied to the catalyst and it is possible to produce an exhaust gas purification catalyst in which a state of high catalytic activity is maintained.

In addition, the barium compound exhibits the effect of suppressing HC poisoning of palladium, which is the noble metal catalyst. Therefore, in cases where palladium is used as the noble metal catalyst, because the barium compound is added to the carrier, it is possible to prevent degradation of the palladium due to HC poisoning and it is possible to maintain the exhaust gas purification catalyst in a state of high catalytic activity.

In addition, although not limiting the present invention, the method for adding the barium compound to the carrier can be carried out according to the following procedure. First, a barium solution is prepared by dissolving a barium compound (for example, barium acetate) in a solvent (for example, water). This aqueous barium solution is added to a slurry in which a catalyst material (for example, a ceria-zirconia composite oxide) contained in the carrier is dispersed, stirring and then drying. By maintaining the obtained powder under high-temperature conditions (for example, approximately 400° C. to 600° C.) for a prescribed period of time, a carrier to which the barium compound is added is obtained. In this way, by adding the barium compound as a solution obtained by dissolving the barium compound in water, it is possible to disperse the barium compound throughout the carrier more uniformly than a case in which the barium compound is added in the form of particles. In addition, a barium compound such as that mentioned above can be added either before or after the noble metal catalyst is supported on the carrier. It is preferable for the barium compound to be added after the noble metal catalyst is supported. By doing so, the materials are uniformly dispersed and it is possible to better exhibit the purification capacity of the exhaust gas purification catalyst.

6. Other Additives

In addition, other materials (typically inorganic oxides) can be added as secondary components to the catalyst layer 43 of the exhaust gas purification catalyst disclosed here. These secondary components do not particularly limit the present invention and may be added to one or both of the upstream side catalyst section 44 and the downstream side catalyst section 45b.

Specific examples of these additives include rare earth elements such as lanthanum (La) and yttrium (Y), alkaline earth elements such as calcium, and other transition metal elements. Of these, rare earth elements such as lanthanum and yttrium can improve the specific surface area in high-temperature regions without impairing the catalyst activity, and are therefore preferably used as stabilizers. In addition, the blending proportion of these secondary components is preferably set to be parts by mass to 20 parts by mass (for example, 5 parts by mass each of lanthanum and yttrium) relative to 100 parts by mass of the carrier that constitutes the catalyst layers.

A preferred embodiment of the present invention was explained above.

Next, experimental examples relating to the present invention will be explained, but the experimental examples explained below in no way limit the present invention.

First, in order to compare HC elimination times according to the quantity of Ba added to the upstream side catalyst section, catalyst samples of Example 1 to Example 6 below were prepared.

### Example 1

An exhaust gas purification catalyst, which had an upstream side catalyst section, a downstream side catalyst section and a rhodium catalyst layer and in which barium acetate was added as a Ba compound to the upstream side catalyst section and the downstream side catalyst section, was prepared as Example 1. Moreover, the exhaust gas purification catalyst prepared here was a low-noble metal content exhaust gas purification catalyst in which the content of noble metal catalyst was 2.0 g or less relative to a 1 L volume of the base material. In addition, the base material of the exhaust gas purification catalyst used here was a cylindrical honeycomb base material having a length of 105 mm. In the following explanation of the material composition, g/L means the quantity contained, in 1 L volume of base material.

First, the catalyst for the upstream side catalyst section was prepared. A dispersion liquid was prepared by suspending an alumina powder to which 45 g/L of lanthanum (La) was added in a nitric acid-based Pd solution that contained 1.4 g/L of palladium (Pd). Next, an upstream side catalyst section slurry was obtained by dispersing 50 g/L of a ceria-zirconia composite oxide and, as a binder, 5 g/L of alumina in the dispersion liquid. A catalyst material for the upstream side catalyst section was prepared by drying this upstream side catalyst section slurry for 30 minutes at a temperature of 120° C. and then firing for 2 hours at a temperature of 500° C.

Next, the catalyst for the downstream side catalyst section was prepared. A dispersion liquid was prepared by suspending an alumina powder to which 65 g/L of lanthanum (La) was added in a nitric acid-based Pd solution that contained 0.6 g/L of palladium (Pd). Next, a downstream side catalyst section slurry was obtained by dispersing 85 g/L of a ceria-zirconia composite oxide, 5 g/L barium acetate ((CH₃COO)₂Ba) as a barium compound and 5 g/L of alumina as a binder in the dispersion liquid. A catalyst material for the downstream side catalyst section was prepared by drying this downstream side catalyst section slurry for 30 minutes at a temperature of 120° C. and then firing for 2 hours at a temperature of 500° C.

Next, a rhodium catalyst layer was prepared on the surface of the catalyst layer in the downstream side catalyst section. A dispersion liquid was prepared by suspending a powder containing 55 g/L of zirconia (ZrO₂) in a nitric acid-based Rh solution that contained 0.2 g/L of rhodium (Rh). Next, a rhodium catalyst layer slurry was obtained by dispersing 35 g/L of alumina to which lanthanum (La) was added and, as a binder, 5 g/L of alumina in the dispersion liquid. A catalyst material for the rhodium catalyst layer was prepared by drying this rhodiumn catalyst layer slurry for 30 minutes at a temperature of 120° C. and then firing for 2 hours at a temperature of 500° C.

Next, a slurry was prepared by dispersing the catalyst material for the upstream side catalyst section in an acidic aqueous solution. A region corresponding to 20% of the total length of the cylindrical honeycomb base material from the exhaust gas inlet side end was immersed in the slurry obtained by dispersing the catalyst material for the upstream side catalyst section. Next, the upstream side catalyst section was formed by removing the base material from the slurry, drying for 30 minutes at a temperature of 20° C. and then firing for 2 hours at a temperature of 500° C.

A slurry was then prepared by dispersing the catalyst material for the downstream side catalyst section in an acidic aqueous solution. A region corresponding to 90% of the total length of the cylindrical honeycomb base material from the exhaust gas outlet side end was immersed in the slurry in which the catalyst material for the downstream side catalyst section was dispersed. Next, the downstream side catalyst section was formed by removing the base material from the slurry, drying for 30 minutes at a temperature of 20° C. and then firing for 2 hours at a temperature of 500° C.

A slurry was then prepared by dispersing the catalyst material for the rhodium catalyst layer in an acidic aqueous solution. Next, the surface of the downstream side catalyst section on the cylindrical honeycomb base material was immersed in the slurry in which dispersing the catalyst material for the rhodium catalyst layer was dispersed. Next, the rhodium catalyst layer was formed by removing the base material from the slurry, drying for 30 minutes at a temperature of 20° C. and then firing for 2 hours at a temperature of 500° C.

The exhaust gas purification catalyst obtained in this way was used as the catalyst sample of Example 1.

### Example 2

An exhaust gas purification catalyst was prepared in the same way as in Example 1, except that in order to add barium (Ba) to the catalyst layer in the upstream side catalyst section in the step of preparing the catalyst for the upstream side catalyst section, an aqueous solution containing 5.0 g/L of barium acetate (that is, 5.5 mass % if the total mass of the ceria-zirconia composite oxide contained in the upstream side catalyst section is 100 mass %) was prepared and this aqueous solution of barium acetate was added to the upstream side catalyst section slurry, and this exhaust gas purification catalyst was used as the catalyst sample of Example 2.

### Example 3

An exhaust gas purification catalyst was prepared in the same way as in Example 1, except that in order to add barium (Ba) to the catalyst layer in the upstream side catalyst section in the step of preparing the catalyst for the upstream side catalyst section, an aqueous solution containing 10 g/L of barium acetate (that is, 11 mass % if the total mass of the ceria-zirconia composite oxide contained in the upstream side catalyst section is 100 mass %) was prepared and this aqueous solution of barium acetate was added to the upstream side catalyst section slurry, and this exhaust gas purification catalyst was used as the catalyst sample of Example 3.

### Example 4

An exhaust gas purification catalyst was prepared in the same way as in Example 1, except that in order to add barium (Ba) to the catalyst layer in the upstream side catalyst section in the step of preparing the catalyst for the upstream side catalyst section, an aqueous solution containing 15 g/L of barium acetate (that is, 16 mass % if the total mass of the ceria-zirconia composite oxide contained in the upstream side catalyst section is 100 mass %) was prepared and this aqueous solution of barium acetate was added to the upstream side catalyst section slurry, and this exhaust gas purification catalyst was used as the catalyst sample of Example 4.

### Example 5

An exhaust gas purification catalyst was prepared in the same way as in Example 1, except that in order to add barium (Ba) to the catalyst layer in the upstream side catalyst section in the step of preparing the catalyst for the upstream side catalyst section, an aqueous solution containing 20 g/L of barium acetate (that is, 22 mass % if the total mass of the ceria-zirconia composite oxide contained in the upstream side catalyst section is 100 mass %) was prepared and this aqueous solution of barium acetate was added to the upstream side catalyst section slurry, and this exhaust gas purification catalyst was used as the catalyst sample of Example 5.

### Example 6

An exhaust gas purification catalyst was prepared in the same way as in Example 1, except that in order to add barium (Ba) to the catalyst layer in the upstream side catalyst section in the step of preparing the catalyst for the upstream side catalyst section, an aqueous solution containing 30 g/L of barium acetate (that is, 32 mass % if the total mass of the ceria-zirconia composite oxide contained in the upstream side catalyst section is 100 mass %) was prepared and this aqueous solution of barium acetate was added to the upstream side catalyst section slurry, and this exhaust gas purification catalyst was used as the catalyst sample of Example 6.

[Durability Test]

The samples of Example 1 to Example 6 were subjected to a 50 hour durability test at a bed temperature of 1000° C. by being exposed to a flow of exhaust gas emitted from a V8 engine (3UZ-FE).

[Measurement of Time Required for Elimination of 50% of HC]

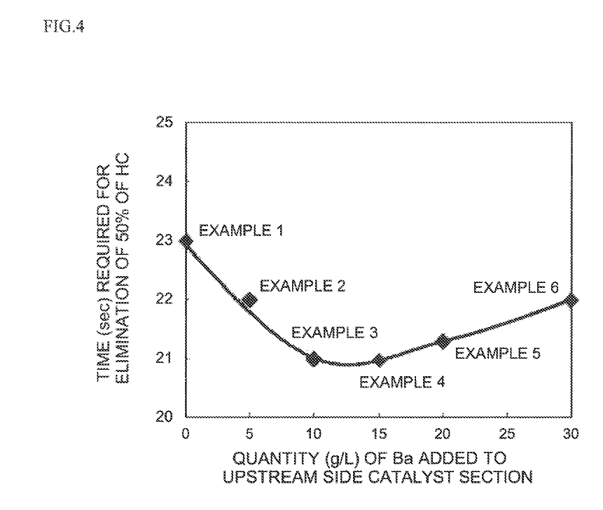

Following the durability test, the samples of Example 1 to Example 6 were measured in terms of the time required to eliminate 50% of HC. Following the durability test, the catalyst samples were each mounted below the floor of a vehicle equipped with a 2.4 L in-line 4 cylinder engine, and the combustion state of the engine was maintained at the theoretical air-fuel ratio. Exhaust gas emitted by the engine was heated to 200° C. to 450° C. at a rate of temperature increase of 10° C./min by a heat exchanger while flowing through the catalyst sample. The HC elimination rate was measured by analyzing the exhaust gas components at the inlet side and outlet side of the catalyst sample during the heating. The time required to eliminate 50% of the HC was calculated from these results. This calculated time was deemed to be the “time required for elimination of 50% of HC”, and is shown in FIG. 4.

As is clear from FIG. 4, the catalyst sample of Example 1, in which the content of Ba in the upstream side catalyst section was 0 (zero), required a time of 23 seconds to eliminate 50% of the HC. However, the catalyst samples of Example 2 to Example 6, in which the upstream side catalyst section contained Ba, required less time than Example 1 to eliminate 50% of the HC, and therefore exhibited excellent catalytic activity. In particular, the catalyst samples of Example 3 to Example 5, in which the content of Ba in the upstream side catalyst section was 1.0 g/L to 20 g/L, required approximately 21 seconds to eliminate 50% of the HC, and therefore exhibited even better catalytic activity. Therefore, from the perspective of improving catalytic activity in terms of time, it is found from the graph in FIG. 4 that the content of Ba in the upstream side catalyst section should be 8 g/L to 20 g/L, preferably 9 g/L to 18 g/L, and more preferably 10 g/L to 15 g/L, and by converting these values, it is found that the content of Ba in the upstream side catalyst section should be a quantity corresponding to 8 mass % to 22 mass %, preferably 9 mass % to 20 mass %, and more preferably 11 mass % to 16 mass %, if the total mass of the ceria-zirconia composite oxide contained in the upstream side catalyst section is 100 mass %.

Next, in order to compare HC elimination temperatures according to the quantity of Ba added to the downstream side catalyst section, catalyst samples of Example 7 to Example 14 below were prepared.

### Example 7

An exhaust gas purification catalyst was prepared in the same way as in Example 1, except that in order to add barium (Ba) to the catalyst layer in the upstream side catalyst section in the step of preparing the catalyst for the upstream side catalyst section in Example 1, an aqueous solution containing 5 g/L of barium acetate was prepared and this aqueous solution of barium acetate was added to the upstream side catalyst section slurry and that in the step of preparing the catalyst for the downstream side catalyst section in Example 1, the downstream side catalyst section slurry was prepared without adding barium (Ba) (that is, barium acetate) to the downstream side catalyst section, and this exhaust gas purification catalyst was used as the catalyst sample of Example 7.

### Example 8

An exhaust gas purification catalyst was prepared in the same way as in Example 7, except that in order to add barium (Ba) to the catalyst layer in the downstream side catalyst section in the step of preparing the catalyst for the downstream side catalyst section, an aqueous solution containing 2.5 g/L of barium acetate (that is, 1.6 mass % if the total mass of the ceria-zirconia composite oxide contained in the downstream side catalyst section is 100 mass %) was prepared and this aqueous solution of barium acetate was added to the downstream side catalyst section slurry, and this exhaust gas purification catalyst was used as the catalyst sample of Example 8.

### Example 9

An exhaust gas purification catalyst was prepared in the same way as in Example 7, except that in order to add barium (Ba) to the catalyst layer in the downstream side catalyst section in the step of preparing the catalyst for the downstream side catalyst section, an aqueous solution containing 5.0 g/L of barium acetate (that is, 3.2 mass % if the total mass of the ceria-zirconia composite oxide contained in the downstream side catalyst section is 100 mass %) was prepared and this aqueous solution of barium acetate was added to the downstream side catalyst section slurry, and this exhaust gas purification catalyst was used as the catalyst sample of Example 9.

### Example 10

An exhaust gas purification catalyst was prepared in the same way as in Example 7, except that in order to add barium (Ba) to the catalyst layer in the downstream side catalyst section in the step of preparing the catalyst for the downstream side catalyst section, an aqueous solution containing 7.5 g/L of barium acetate (that is, 4.8 mass % if the total mass of the ceria-zirconia composite oxide contained in the downstream side catalyst section is 100 mass %) was prepared and this aqueous solution of barium acetate was added to the downstream side catalyst section slurry, and this exhaust gas purification catalyst was used as the catalyst sample of Example 10.

### Example 11

An exhaust gas purification catalyst was prepared in the same way as in Example 7, except that in order to add barium (Ba) to the catalyst layer in the downstream side catalyst section in the step of preparing the catalyst for the downstream side catalyst section, an aqueous solution containing 10 g/L of barium acetate (that is, 6.4 mass % if the total mass of the ceria-zirconia composite oxide contained in the downstream side catalyst section is 100 mass %) was prepared and this aqueous solution of barium acetate was added to the downstream side catalyst section slurry, and this exhaust gas purification catalyst was used as the catalyst sample of Example 11.

### Example 12

An exhaust gas purification catalyst was prepared in the same way as in Example 7, except that in order to add barium (Ba) to the catalyst layer in the downstream side catalyst section in the step of preparing the catalyst for the downstream side catalyst section, an aqueous solution containing 15 g/L of barium acetate (that is, 9.5 mass % if the total mass of the ceria-zirconia composite oxide contained in the downstream side catalyst section is 100 mass %) was prepared and this aqueous solution of barium acetate was added to the downstream side catalyst section slurry, and this exhaust gas purification catalyst was used as the catalyst sample of Example 12.

### Example 13

An exhaust gas purification catalyst was prepared in the same way as in Example 7, except that in order to add barium (Ba) to the catalyst layer in the downstream side catalyst section in the step of preparing the catalyst for the downstream side catalyst section, an aqueous solution containing 20 g/L of barium acetate (that is, 13 mass % if the total mass of the ceria-zirconia composite oxide contained in the downstream side catalyst section is 100 mass %) was prepared and this aqueous solution of barium acetate was added to the downstream side catalyst section slurry, and this exhaust gas purification catalyst was used as the catalyst sample of Example 13.

### Example 14

An exhaust gas purification catalyst was prepared in the same way as in Example 7, except that in order to add barium (Ba) to the catalyst layer in the downstream side catalyst section in the step of preparing the catalyst for the downstream side catalyst section, an aqueous solution containing 30 g/L of barium acetate (that is, 19 mass % if the total mass of the ceria-zirconia composite oxide contained in the downstream side catalyst section is 100 mass %) was prepared and this aqueous solution of barium acetate was added to the downstream side catalyst section slurry, and this exhaust gas purification catalyst was used as the catalyst sample of Example 14.

[Durability Test]

The samples of Example 7 to Example 14 were subjected to a 50 hour durability test at a bed temperature of 100° C. b by being exposed to a flow of exhaust gas emitted from a V8 engine (3UZ-FE).

[Measurement of Temperature Required for Elimination of 50% of HC]

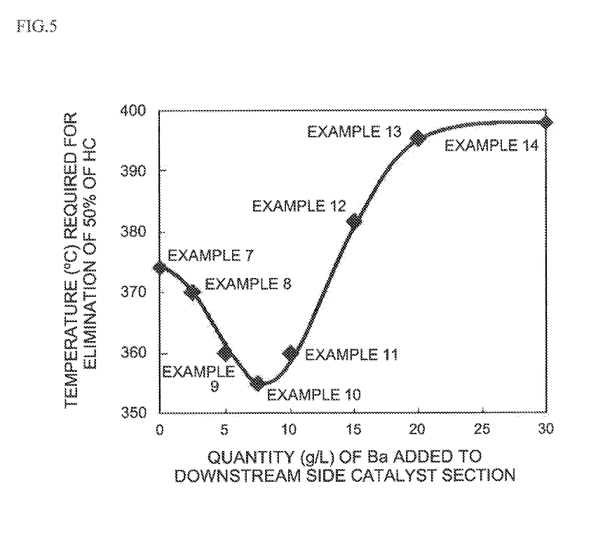

Following the durability test, the samples of Example 7 to Example 14 were measured in terms of the temperature required to eliminate 50% of HC. In the same way as the test for measuring the time required to eliminate 50% of HC, the durability test was carried out and the catalyst samples were then each mounted below the floor of a vehicle equipped with a 2.4 L in-line 4 cylinder engine, and the combustion state of the engine was maintained at the theoretical air-fuel ratio. Exhaust gas emitted by the engine was heated to 200° C. to 450° C. at a rate of temperature increase of 10° C./min by a heat exchanger while flowing through the catalyst sample. The HC elimination rate was measured by analyzing the exhaust gas components at the inlet side and outlet side of the catalyst sample during the heating. The temperature at which it was possible to eliminate 50% of the HC was calculated from these results. This calculated temperature was deemed to be the “temperature required for elimination of 50% of HC”, and is shown in FIG. 5.

As shown in FIG. 5, the catalyst samples of Example 7, in which the content of Ba in the downstream side catalyst section was 0 (zero), and Example 8, in which the content of Ba in the downstream side catalyst section was 2.5 g/L, required a temperature in excess of 370° C. to eliminate 50% of the HC. This is thought to be because the content of Ba in the downstream side catalyst section is low, thereby facilitating poisoning by HC and causing the catalytic activity to decrease. However, the catalyst samples of Example 12 to Example 14, in which the content of Ba in the downstream side catalyst section was 15 g/L to 30 g/L, required a temperature in excess of 380° C. to eliminate 50% of the HC. This is thought to be because the content of Ba in the downstream side catalyst section is too high, thereby causing the crystal structure of the ceria-zirconia composite oxide to be destroyed and causing the oxygen storage capacity of the ceria-zirconium composite oxide to deteriorate.

The catalyst samples of Example 9 to Example 11 required a temperature of approximately 360° C. to eliminate 50% of the HC, which is lower than the temperature required to eliminate 50% of the HC with the catalyst samples of Example 7, Example 8 and Example 12 to Example 14, and the catalyst samples of Example 9 to Example 11 therefore exhibit excellent catalytic activity at lower temperatures. Therefore, from the perspective of improving the catalytic activity at low temperatures, the content of Ba in the downstream side catalyst section should be 5 g/L to 10 g/L, and preferably 7 g/L to 9 g/L, and by converting these values, it is found that the content of Ba in the downstream side catalyst section should be a quantity corresponding to 3 mass % to 7 mass %, and preferably 4 mass % to 6 mass %, if the total mass of the ceria-zirconia composite oxide contained in the downstream side catalyst section is 100 mass %.

The present invention was explained in detail above, but the embodiments and working examples shown above are merely exemplary, and the invention disclosed here includes embodiments and working examples obtained by variously modifying or altering the specific examples shown above.

What is claimed is:

1. An exhaust gas purification catalyst which purifies exhaust gas emitted from an internal combustion engine,
the exhaust gas purification catalyst comprising:
a porous base material; and
a catalyst layer which is formed on said porous base material, and has at least a ceria-zirconia composite oxide as a carrier, and which has palladium as a noble metal catalyst supported on said carrier, wherein
the catalyst layer is provided with at least an upstream side catalyst section disposed on the upstream side in the exhaust gas flow direction and a downstream side catalyst section disposed on the downstream side in the exhaust gas flow direction,
Ba is added to the upstream side catalyst section and the downstream side catalyst section,
a quantity of Ba added to the upstream side catalyst section is a quantity corresponding to 8 to 22 mass % when a total mass of a ceria-zirconia composite oxide contained in said upstream side catalyst section is 100 mass %, and
a quantity of Ba, added to the downstream side catalyst section is a quantity corresponding to 3 to 7 mass % when the total mass of a ceria-zirconia composite oxide contained in said downstream side catalyst section is 100 mass %.

2. The exhaust gas purification catalyst according to claim 1, wherein the length of the upstream side catalyst section in the exhaust gas flow direction accounts for at least 10 to 20% of the overall length of the catalyst layer along said direction from the exhaust gas inlet side end.

3. The exhaust gas purification catalyst according to claim 1, wherein the length of the downstream side catalyst section in the exhaust gas flow direction accounts for at least 80 to 90% of the overall length of the catalyst layer along said direction from the exhaust gas outlet side end.

4. The exhaust gas purification catalyst according to claim 1, wherein the content of the ceria-zirconia composite oxide contained in the downstream side catalyst section is higher than the content of the ceria-zirconia composite oxide contained in the upstream side catalyst section.

5. The exhaust gas purification catalyst according to claim 1, wherein the upstream side catalyst section and the downstream side catalyst section further contain alumina as the carrier.

6. The exhaust gas purification catalyst according to claim 1, wherein
a quantity of palladium supported on the carrier in the upstream side catalyst section is a quantity that corresponds to 0.5 to 3 mass % when a total mass of said carrier is 100 mass %,
a quantity of palladium supported on the carrier in the downstream side catalyst section is a quantity that corresponds to 0.1 to 1 mass % when a total mass of said carrier is 100 mass %,
the quantity of palladium supported on the carrier in the upstream side catalyst section is higher than the quantity of palladium supported on the carrier in the downstream side catalyst section.

7. The exhaust gas purification catalyst according to claim 1, further comprising a rhodium catalyst layer, which is provided with at least one type of carrier and rhodium supported on said carrier, on the surface of the catalyst layer in the downstream side catalyst section.

8. The exhaust gas purification catalyst according to claim 1, wherein a blending ratio of ceria and zirconia in the ceria-zirconia composite oxide contained as the catalyst layer carrier is such that the ceria/zirconia ratio is 0.25 to 0.75.

9. The exhaust gas purification catalyst according to claim 1, wherein the upstream side catalyst section or the downstream side catalyst section further contains lanthanum.

10. The exhaust gas purification catalyst according to claim 1, wherein the Ba added to the upstream side catalyst section and the downstream side catalyst is barium acetate.
